(19) United States
(12) Patent Application Publication
(10) Pub. No.: US 2013/0145301 A1
(43) Pub. Date: Jun. 6, 2013

(54) METHOD AND APPARATUS FOR DISPLAYING TASK MANAGEMENT SCREEN OF MOBILE DEVICE HAVING TOUCH SCREEN

(71) Applicant: SAMSUNG ELECTRONICS CO., LTD., Gyeonggi-do (KR)

(72) Inventors: Jinyong KIM, Seoul (KR); Minkoo KANG, Seoul (KR); Jihyun AHN, Seoul (KR); Changmo YANG, Gyeonggi-do (KR); Eunhye LEE, Seoul (KR); Jinyoung JEON, Seoul (KR)

(73) Assignee: SAMSUNG ELECTRONICS CO., LTD., Gyeonggi-do (KR)

(21) Appl. No.: 13/705,785

(22) Filed: Dec. 5, 2012

(30) Foreign Application Priority Data
Dec. 6, 2011 (KR) 10-2011-0129580

(51) Int. Cl. G06F 3/0481

(52) U.S. Cl. CPC G06F 3/0481
USPC 715/772

(57) ABSTRACT

A method and apparatus are provided for displaying a task management screen of a mobile device having a touch screen. When a task management program is executed, a control unit of the apparatus constructs a task management map in which at least one application is arranged along a first axis and a task history of said at least one application is arranged along a second axis. Then the control unit displays a task management screen in which an application item related to the application on the first axis is displayed in a first direction and a task history item related to the task history on the second axis is displayed in a second direction.

### CLAIM OF PRIORITY

This application claims the benefit under 35 U.S.C. §119(a) from a Korean patent application filed on Dec. 6, 2011 in the Korean Intellectual Property Office and assigned Serial No. 10-2011-0129580, the entire disclosure of which is hereby incorporated by reference in its entirety.

### BACKGROUND OF THE INVENTION

1. Field of the Invention

The present invention relates to a method and apparatus for utilizing a mobile terminal to perform one or more tasks. More particularly, the present invention relates to displaying a task management screen of a mobile device having a touch screen.

2. Description of the Related Art

Recent trends in devices mobile device include having a multitasking function by which several tasks can be performed simultaneously. For increasing cases where many applications are executed simultaneously, a task management program is installed in a mobile device so as to effectively manage several tasks.

Additionally, the popularization of a smart phone not only generalizes multitasking, but also increases the use of a mobile device having a touch screen. Therefore, a user interface is required that permits more conveniently management of several tasks at the same time.

However, a conventional user interface based on simple text or icons fails to provide sufficiently intuitive and rapid accessibility in a modern multitasking environment of a smart phone that offers a touch screen.

### BRIEF SUMMARY OF THE INVENTION

Accordingly, the present invention addresses at least some of the above-mentioned problems and/or disadvantages and provides at least the advantages described below.

An exemplary aspect of the present invention provides a method and apparatus for displaying a task management screen in which a task management map is constructed when a task management program is executed in a mobile device, a task management screen is displayed using the task management map, and a moving and switching screen is displayed using the task management screen.

According to one exemplary aspect of the present invention, provided is a method for displaying a task management screen of a mobile device having a touch screen, the method preferably includes: when a task management program is executed, constructing by a control unit a task management map in which at least one application is arranged along a first axis and a task history of each of said at least one application is arranged along a second axis; and displaying by a display a task management screen in which an application item related to the application on the first axis is displayed in a first direction and a task history item related to the task history on the second axis is displayed in a second direction.

According to another exemplary aspect of the present invention, an apparatus for displaying a task management screen of a mobile device having a touch screen, and the apparatus includes: a control unit configured to, when a task management program is executed, construct a task management map in which at least one application is arranged along a first axis and a task history of each application is arranged along a second axis, and further configured to display a task management screen in which an application item related to the application on the first axis is displayed in a first direction and a task history item related to the task history on the second axis is displayed in a second direction.

According to exemplary aspects of the present invention, a task management map is constructed and a task management screen is displayed using the map. Therefore, a user can intuitively and rapidly understand the execution status and the execution history of an application. Also, a task switch is possible through the task management screen which is more convenient than known heretofore.

Other exemplary aspects, advantages, and salient features of the invention will become apparent to those of ordinary skill in the art from the following detailed description, which, taken in conjunction with the annexed drawings, discloses exemplary embodiments of the invention.

### BRIEF DESCRIPTION OF THE DRAWINGS

FIG. 1 is a block diagram illustrating a configuration of a mobile device in accordance with an exemplary embodiment of the present invention.

FIG. 2 is a flow diagram illustrating a task management method in accordance with an exemplary embodiment of the present invention.

FIG. 3 is a diagram illustrating a method for constructing a task management map in accordance with an exemplary embodiment of the present invention.

FIG. 4 is a diagram illustrating a task management screen for managing the execution state of an application in accordance with an exemplary embodiment of the present invention.

FIGS. 5A and 5B are diagrams illustrating a task management screen for managing the execution state of an application in accordance with another exemplary embodiment of the present invention.

FIG. 6 is a diagram illustrating a process of moving and switching an application item in accordance with another exemplary embodiment of the present invention.

FIG. 7 is a diagram illustrating a process of switching an application in accordance with still another exemplary embodiment of the present invention.

### DETAILED DESCRIPTION

Exemplary, non-limiting embodiments of the present invention will now be described more fully with reference to the accompanying drawings. The presently claimed invention may, however, be embodied in many different forms and the appended claims should not be construed as limited to the exemplary embodiments set forth herein. Rather, the disclosed exemplary embodiments are provided so that this disclosure will be thorough and complete, and will provide the artisan with enabling knowledge of the invention in order to practice the claimed invention without undue experimentation by those of ordinary skill in the art. The principles and features of the present invention may be employed in varied and numerous exemplary embodiments without departing from the spirit of the invention and the scope of the appended claims.

Furthermore, well-known or widely used techniques, elements, structures, and processes may not be described or illustrated in detail to avoid obscuring the appreciation of the present invention by an artisan. Although the drawings represent exemplary embodiments of the invention, the drawings are not necessarily to scale and certain features that may be exaggerated or omitted in order to better illustrate and explain the present invention.

In this disclosure, an item refers to a unit used for identifying or executing an application, a folder, and the like. Such an item may be represented as any shape, form, color or their combinations, for example, an execution screen, a thumbnail image, or an icon.

In this disclosure, a task history refers to a previously executed record of applications. For example, in case of an application that executes particular content, a task history includes the previously executed content. Also, in case of an application having a hierarchical menu structure, a task history is directed to an upper or lower menu. And also, in case of a web browser application, a task history includes a previously-browsed web page.

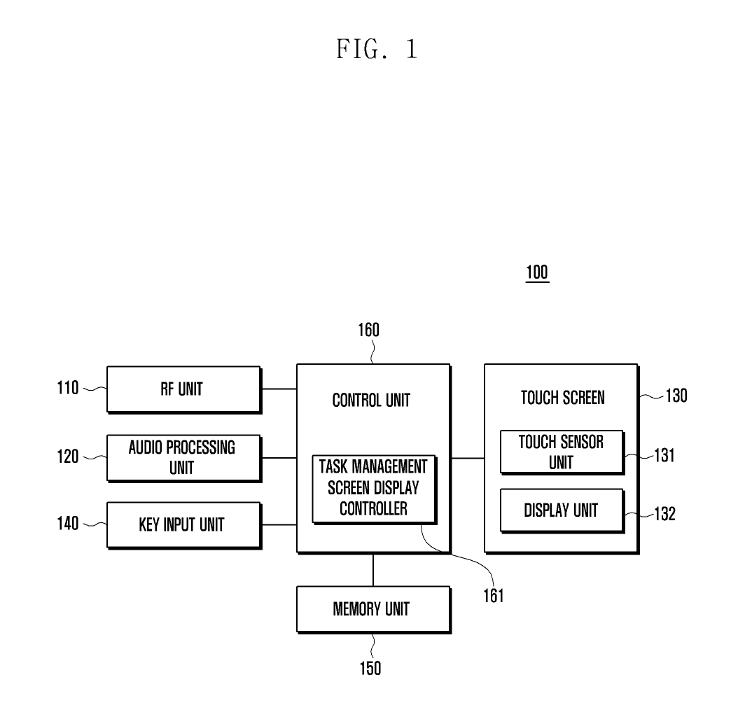

FIG. 1 is a block diagram illustrating a configuration of a mobile device in accordance with an exemplary embodiment of the present invention. As shown in FIG. 1, the mobile device 100 may include a radio frequency (RF) unit 110, an audio processing unit 120, a touch screen 130, a key input unit 140, a memory unit 150, and a control unit 160.

The RF unit 110 performs a function to transmit and receive data for a wireless communication. For example, the RF unit 110 may include an RF transmitter that up-converts the frequency of an outgoing signal and then amplifies the signal, and an RF receiver that low-noise amplifies (LNAs) an incoming signal and down-converts the frequency of the signal. Also, the RF unit 110 outputs data received through a radio channel to the control unit 160, and sends data outputted from the control unit 160 through a radio channel.

The audio processing unit 120 may be composed of one or more CODECs which may include a data CODEC for processing packet data and an audio CODEC that processes audio signals such as voice. The audio processing unit 120 converts digital audio signals into analog audio signals through the audio CODEC and then reproduces them through a transducer such as a speaker (SPK). Also, the audio processing unit 120 converts analog audio signals inputted from the microphone (MIC) into digital audio signals through the audio CODEC.

The touch screen 130 preferably includes a touch sensor unit 131 and a display unit 132. The touch sensor unit 131 detects a user's touch input. The touch sensor unit 131 may be composed of touch sensors of capacitive overlay type, resistive overlay type, or infrared beam type, or pressure sensors, just to some possible non-limiting examples. Other sensors detecting touch or pressure may be alternatively or additionally used for the touch sensor unit 131. The touch sensor unit 131 detects user's touch input, creates a detection signal, and sends the signal to the control unit 160. This detection signal containing coordinate data corresponding to user's touch input. If a user inputs a touch and move action, the touch sensor unit 131 creates a detection signal having coordinate data of touch and move path and then sends the detection signal to the control unit 160.

More particularly, with continued reference to FIG. 1, the touch sensor unit 131 may detect a user's input in a task management screen. The user input may be a touch (including a multi touch), a drag, or the like.

The display unit 132 may be formed of LCD (liquid crystal display), OLED (organic light emitting diodes), AMOLED (active matrix OLED), or any other type of Thin Film Technology (TFT) Display. The display unit 132 visually offers a menu of the mobile device 100, inputted data, function setting information, and any other information to a user. Particularly, the display unit 132 performs a function to output a task management screen.

Although the mobile device 100 may have the above-discussed touch screen, exemplary embodiments of this invention do not always applied to the mobile device 100 having the touch screen. In case of being applied to any mobile device having no touch screen, the touch screen 130 shown in FIG. 1 may be modified to perform a function of the display unit 132 only.

The key input unit 140 receives user's key manipulations for controlling the mobile device 100, creates input signals, and delivers them to the control unit 160. The key input unit 140 may be formed of a keypad having alphanumeric keys and navigation keys, and may further include function keys disposed on sides of the mobile device 100. In some embodiments, the key input unit 140 may be removed from the mobile device that can operate through the touch screen 130 only.

The memory unit 150 comprises a non-transitory machine readable storage to store programs and data required for operation of the mobile device 100 and may include a program region and a data region. The program region may store a program for controlling the whole operations of the mobile device 100, an operating system (OS) for booting the mobile device 100, an application required for playing multimedia contents, an application required for performing optional functions of the mobile device 100, such as a camera, an image view, or a video play, and the like. The data region may store data created while the mobile device 100 is used, such as images, videos, phonebook, audio data, and the like.

With continued reference to FIG. 1, the control unit 160 preferably controls the entire operations for elements of the mobile device 100. Particularly, when a task management program is executed, the control unit 160, which comprises hardware such as a processor or microprocessor loaded with machine executable code is configured to control a series of processes of constructing a task management map and of displaying a task management screen using the task management map. For this operation, the control unit 160 may further include a dedicated task management screen display controller 161.

According to an exemplary embodiment of the present invention, when a task management program is executed, the task management screen display controller 161 may construct a task management map in which at least one application is arranged for display along the first axis and a task history of each application is arranged for display along the second axis. Additionally, the task management screen display controller 161 may, for example, be configured to control the touch screen to display a task management screen in which an application item related to the application on the first axis is displayed in the first direction and a task history item related to the task history on the second axis is displayed in the second direction.

In the task management screen, the first direction may be the display of a vertical direction, and the second direction may be a display of a horizontal direction. In another exemplary embodiment of this invention, each of the first and second directions may of display may be a horizontal direction.

When a move command is input after the task management screen is displayed, the task management screen display controller 161 may control the touch screen 130 to display a moving screen in which the application item is moved for display in the first direction and the task history item is moved in the second direction for display. That is, the touch screen 130 displays a screen in which certain items change position on the display in accordance to a selection.

Also, when a selection command is received (typically via the input unit) after the moving screen is displayed, the task management screen display controller 161 may automatically select the application item or the task history item in the task management screen and then control the touch screen 130 to display a switched application related to the selected application item (i.e., icons) or a switched task history related to the selected task history item.

Although the task management screen display controller 161 is illustrated and described as a separate function block in the control unit 160, this configuration is exemplary only and not to be considered as a limitation of the scope of the presently claimed invention. Alternatively, the control unit 160 itself may perform a particular function of the task management screen display controller 161.

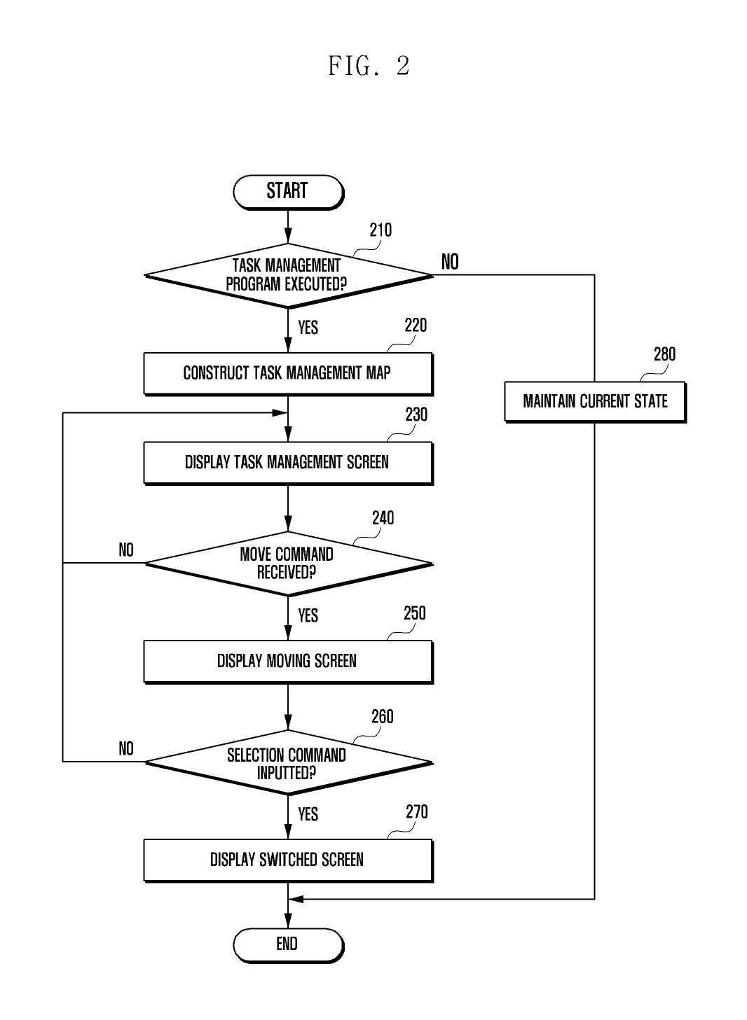

FIG. 2 is a flow diagram illustrating a task management method in accordance with an exemplary embodiment of the present invention.

Referring now to FIG. 2, at the outset, the control unit 160 (of FIG. 1) determines at (step 210) whether a task management program is executed. The task management program may be provided by the manufacturer of the mobile device 100 or can be separately received and then installed. A user may enter an execution command of the task management program through the key input unit 140 or the touch sensor unit 141 by selecting an icon related to the task management program displayed on the display unit 132. The control unit 160 receives user's input signal and determines whether the task management program is executed. It is also within the spirit and scope of the invention that the device may interpret gestures from a user to perform some of the tasks.

If the task management program is executed, at (step 220) the control unit 160 constructs a task management map disclosure, the task management map means a group of applications, currently executing or previously executed, and their task histories.

According to an exemplary embodiment of this invention, the control unit 160 may construct the task management map and control output of the task management map by the display in which at least one application is arranged along the first axis and a task history of each application is arranged along the second axis of the display.

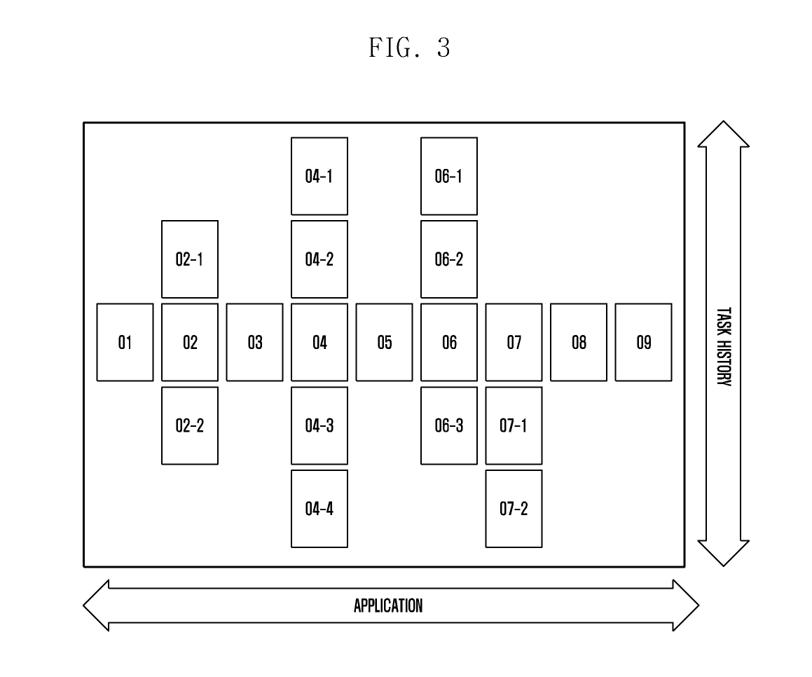

FIG. 3 is a diagram illustrating a method for constructing a task management map in accordance with an exemplary embodiment of the present invention.

As shown in FIG. 3, applications (01, 02, 03, . . . , 09) are arranged along the first axis, and task histories (02-1, 02-2, 04-1, . . . , 07-2) are arranged along the second axis. Such applications and their task histories may be arranged in the order of execution time. In the case of an application having a hierarchical menu structure, an upper or lower menu may be arranged above or below the application. The axes of the application and task history may be changed with each other. In other words, the applications may be arranged lengthwise, and the task histories may be arranged widthwise.

The task management map shown in FIG. 3 is not displayed itself and merely used to display a task management screen on the display unit 132. That is, the map is constructed in background and not displayed on the screen, but merely used to configure the display of the task management screen.

Returning now to FIG. 2, if the control unit determines that the task management program is not executed, then at (step 280) the control unit 160 maintains a current state.

The control unit 160 is configured to control the display unit 132 to display the task management screen in which application items related to the applications on the first axis are displayed in the first direction and task history items related to the task histories on the second axis are displayed in the second direction. Unlike the task management map that is not shown to a user, the task management screen is in fact shown to the user.

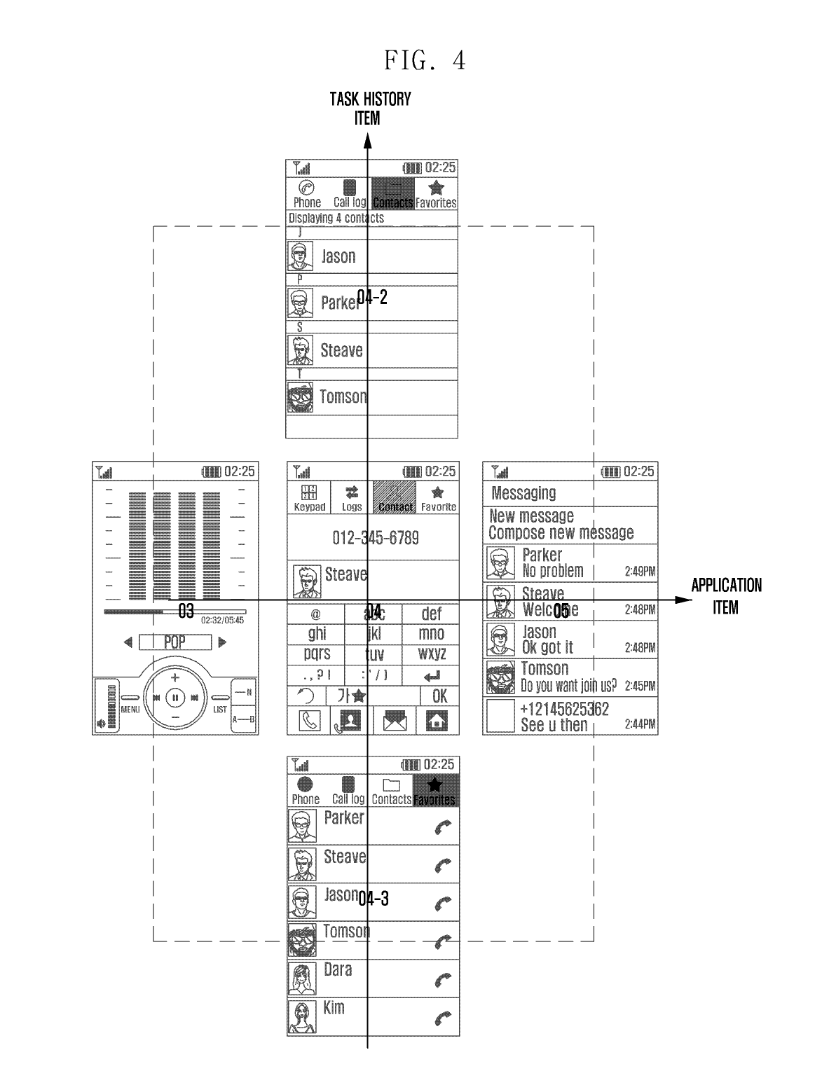

FIG. 4 is a diagram illustrating a task management screen for managing the execution state of an application in accordance with an exemplary embodiment of the present invention.

As shown in FIG. 4, displayed in the task management screen are application items and task history items which are arranged crosswise. In FIG. 4, the first direction is a vertical direction, and the second direction is a horizontal direction. Displayed at the center of the task management screen is an application item related to a currently executing application. Task history items related to (associated with) the currently executing application are displayed in the first direction. Also, task history items associated with other applications are displayed in the second direction. The task management screen shown in FIG. 4 corresponds to the task management map shown in FIG. 3.

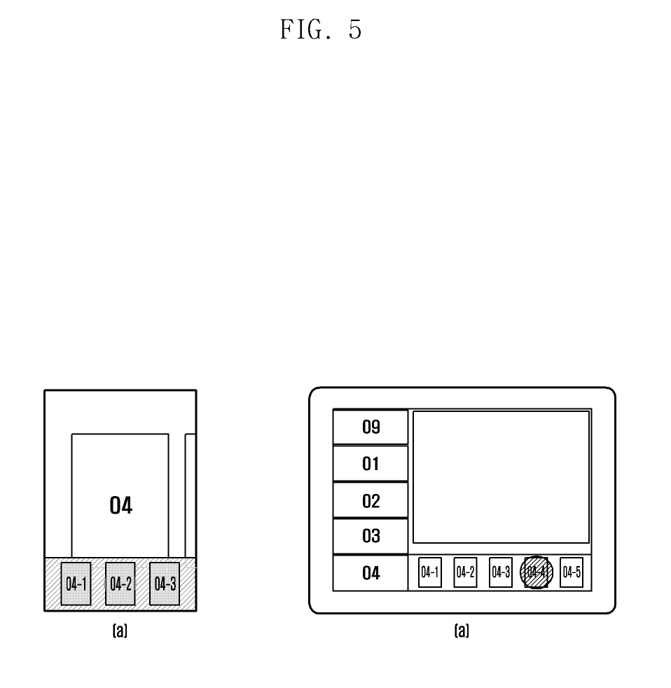

FIGS. 5A and 5B are diagrams illustrating a task management screen for managing the execution state of an application in accordance with another exemplary embodiment of the present invention.

As shown in FIG. 5A, the first and second directions are all horizontal. In FIG. 5A, application items displayed in the first direction are located at the upper portion of the task management screen, and task history items displayed in the second direction are located at the lower portion. Additionally, the application item is displayed having a greater size than the task history item.

In FIG. 5B, as is shown in the drawing, the first direction is vertical and the second direction is horizontal, without being centrally intersected. Application items displayed in the first direction are located lengthwise at the left portion of the display unit 132, and task history items that are displayed in the second direction are located widthwise at the lower portion of the display unit 132. The arrangement and the size of the application item and the task history item may be varied according to the particular application.

Using the above-discussed task management screen in which application items related to the applications on the first axis are displayed in the first direction and task history items related to the task histories on the second axis are displayed in the second direction, a user can intuitively and rapidly understand the execution state and the execution history of an application.

Returning now to FIG. 2, at step 240 after displaying the task management screen, the control unit 160 determines whether a move command is received.

If a move command is received, at step 250 the control unit 160 displays a moving screen in which the application item is moved in the first direction and the task history item is moved in the second direction.

In an exemplary embodiment of this invention, a user of the mobile device 100 may move the display of application items or task history items in the task management screen. In this disclosure, a move command includes user's input to the key input unit and user's input to the touch sensor unit 131. For example, if a touch flick is made on the touch sensor unit 131, the control unit 160 detects the flick and may control the display unit 132 to move the displayed items in an arranged direction.

If it is determined at the step 240 that a move command is not received, the control unit 160 maintains the task management screen at step 230.

At step 260, the control unit 160 further determines whether a selection command is received. If a selection command is received, the control unit 160 selects the application item or the task history item in the task management screen and then controls the display unit 132 to display a switched application related to the selected application item or a switched task history related to the selected task history item.

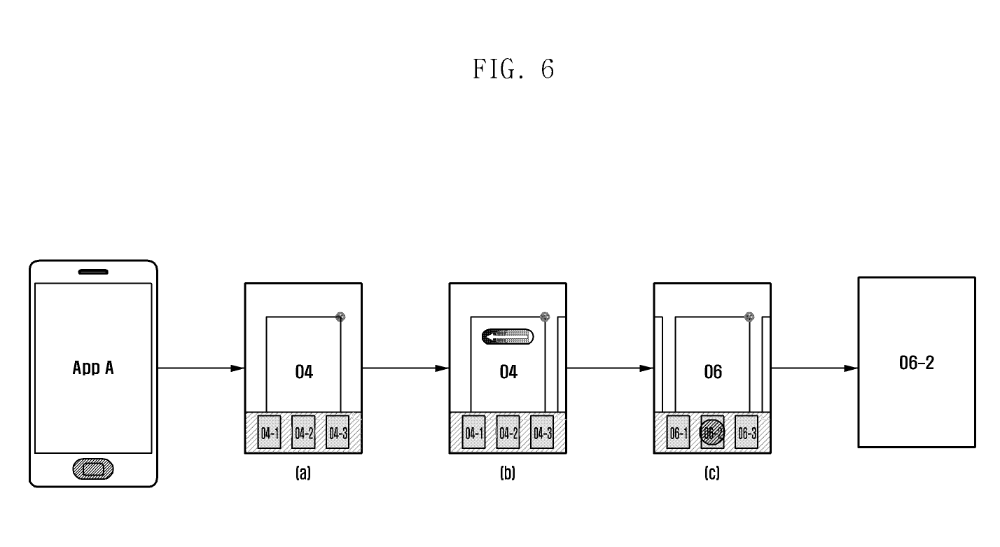

FIG. 6 is a diagram illustrating a process of moving and switching an application item in accordance with another exemplary embodiment of the present invention.

If a user touches and selects a task history item 06-2 displayed in the second portion as shown in stage (c) of FIG. 6, the touch sensor unit 131 detects the touch and the control unit 160 switches from an application 04 to an application 06 and then displays content, menu, or webpage related to the selected task history item 06-2.

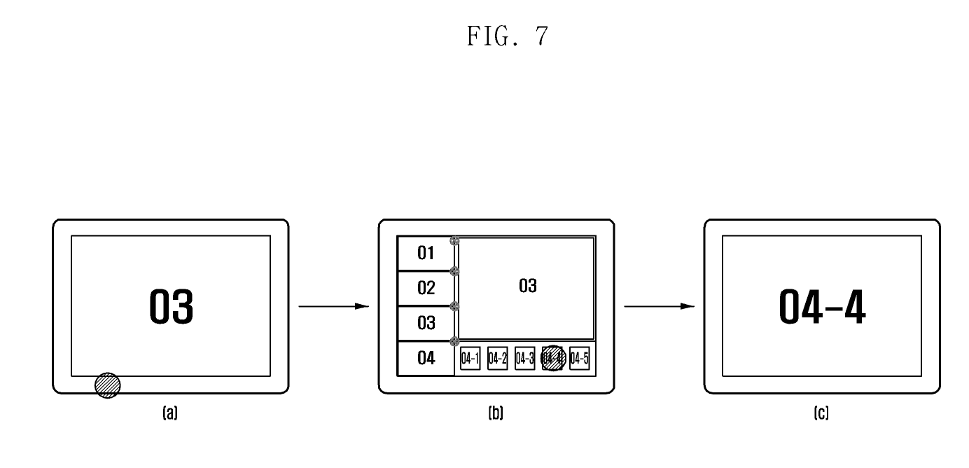

FIG. 7 is a diagram illustrating a process of switching an application in accordance with still another exemplary embodiment of the present invention.

As shown in stage (a) of FIG. 7, the task management program is executed through the key input unit 140, and the task management screen is displayed on the display unit 132. If a user selects an application item 04 in the first portion, task history items of related application are displayed in the second portion. Thereafter, when a user selects a task history item 04-4, the control unit 160 switches an application 03 to an application 04 and then displays content, menu, or webpage related to the selected task history item 04-4.

Returning now to FIG. 2, if at step 260 it is determined that a selection command is not received, then at step 230 the control unit 160 maintains the task management screen.

As discussed above, it is possible to conveniently manage the execution state of applications through the task management screen. The above-described methods according to the present invention can be implemented in hardware, firmware or as software or computer code that is stored on a non-transitory machine readable medium such as a CD ROM, a RAM, a floppy disk, a hard disk, or a magneto-optical disk or computer code downloaded over a network originally stored on a remote recording medium or a non-transitory machine readable medium and stored on a local non-transitory recording medium, so that the methods described herein can be loaded into hardware such as a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. In addition, an artisan understands and appreciates that a “processor” or “microprocessor” constitute hardware in the claimed invention. Under the broadest reasonable interpretation, the appended claims constitute statutory subject matter in compliance with 35 U.S.C. §101.

The terms “unit” or “module” as used herein is to be understood as constituting hardware such as a processor or microprocessor configured for a certain desired functionality in accordance with statutory subject matter under 35 U.S.C. §101 and does not constitute software per se.

While this invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A method for displaying a task management screen of a mobile device having a touch screen, the method comprising:
when a task management program is executed by a control unit, constructing a task management map in which at least one application is arranged along a first axis and a task history of said at least one application is arranged along a second axis; and
displaying a task management screen on a display in which an application item associated with the application on the first axis is displayed in a first direction and a task history item associated with the task history on the second axis is displayed in a second direction.

2. The method of claim 1, further comprising:
after the displaying of the task management screen on the display,
when a move command is detected, the control unit changes the task management screen to display a moving screen that shows movement of the application item in the first direction and movement of the task history item in the second direction.

3. The method of claim 2, further comprising:
after the displaying of the moving screen,
when a selection command is detected, the control unit selects the application item or the task history item displayed in the task management screen; and
displaying a switched application screen associated with the selected application item or a switched task history associated with the selected task history item.

4. The method of claim 1, wherein the first direction comprises a vertical direction and the second direction comprises a horizontal direction.

5. The method of claim 1, wherein both the first direction and the second direction comprise a horizontal direction.

6. The method of claim 1, wherein the application item comprises one of an execution screen, a thumbnail image, and an icon.

7. The method of claim 1, wherein the first and second directions of the moving screen are both horizontal.

8. The method of claim 1, wherein the first and second directions of the moving screen are both vertical.

9. The method of claim 1, wherein the first direction of the moving screen is vertical and the second directions of the moving screen is horizontal.

10. An apparatus for displaying a task management screen of a mobile device having a touch screen, the apparatus comprising:
a control unit configured to construct a task management map, when a task management program is executed, in which at least one application is arranged along a first axis and a task history of said at least one application is arranged along a second axis, and further configured to control display of a task management screen in which an application item associated with the application on the first axis is displayed in a first direction and a task history item associated with the task history on the second axis is displayed in a second direction.

11. The apparatus of claim 10, wherein the control unit is further configured to change the task management screen to display a moving screen of the task management screen, when a move command is detected after the displaying of the task management screen, in which the application item is moved in the first direction and the task history item is moved in the second direction along the moving screen.

12. The apparatus of claim 11, wherein the control unit is further configured to select the application item or the task history item in the task management screen, when a selection command is received after the displaying of the moving screen, and then to control a display of a switched application associated with the selected application item or a switched task history associated with the selected task history item.

13. The apparatus of claim 10, wherein the first direction is a vertical direction and the second direction is a horizontal direction.

14. The apparatus of claim 10, wherein both the first direction and the second direction are a horizontal direction.

15. The apparatus of claim 10, wherein the application item comprises one of an execution screen, a thumbnail image, and an icon.

16. The apparatus of claim 11, wherein the control unit further comprises a task management screen display controller configured to control display of a task management.

17. The apparatus of claim 10, comprising a mobile terminal including an RF unit, an input unit, a touch sensor unit and touchscreen display.
